(19) United States
(12) Patent Application Publication
(10) Pub. No.: US 2024/0198262 A1
(43) Pub. Date: Jun. 20, 2024

(54) Air Filter Medium, Filter Medium Body, and Filter Element

(71) Applicant: MANN+HUMMEL GmbH, Ludwigsburg (DE)

(72) Inventors: Christoph HITZKE, Ebensfeld (DE); Doris WATZLAWZYK, Schwarzenbach (DE); Peter FREMEREY, Heinersreuth (DE)

(21) Appl. No.: 18/532,155

(22) Filed: Dec. 7, 2023

(30) Foreign Application Priority Data
Dec. 19, 2022 (DE) 102022133938.6

(51) Int. Cl. B01D 39/16; B01D 46/52

(52) U.S. Cl. CPC B01D 39/1623; B01D 46/521; B01D 2239/0407; B01D 2239/0464; B01D 2239/1241; B01D 2239/1291; B01D 2275/10

(57) ABSTRACT

An air filter medium with inflow side and outflow side can be flowed through from inflow side to outflow side in a flow direction. An ion exchanger layer with ion exchanger particles is provided. An impregnation layer with impregnated active carbon particles is arranged downstream of the ion exchanger layer. An active layer with non-impregnated active carbon particles is provided. The impregnated active carbon particles are impregnated with an acidic impregnation agent provided with at least one inorganic acid selected from phosphoric acid, sulfuric acid, and hydrochloric acid. A grammage of the ion exchanger particles is between 150 g/m² and 350 g/m². A grammage of the impregnated active carbon particles is between 150 g/m² and 350 g/m². A filter medium body and a filter element are provided with such an air filter medium and used in interior air filters, intake air filters of fuel cells or fume filters.

### BACKGROUND OF THE INVENTION

The invention concerns an air filter medium, in particular for an interior air filter, for an intake air filter of a fuel cell or for a fume filter, a filter medium body with such an air filter medium, and a filter element.

Air filter media are known in principle and, as a core component of filter elements, serve for purifying air flows for downstream uses. For example, interior air filters for passenger compartments of motor vehicles, intake air filters of fuel cells as well as fume or exhaust filters in kitchens are conceivable in this context. Such filter elements are not only supposed to remove particulate contaminants, for example, pollen or fine dust, but also odors, in particular due to gaseous odor substances, or harmful or reactive gaseous substances. Particularly the removal of gas and odor substances is a challenge in this context because the different gas and odor substances, due to their different specific, in particular chemical, properties, can be efficiently removed from an air flow only by tailored adsorbents.

DE 10 2013 011 511 A1 discloses a filter device, in particular for the air to be supplied to a fuel cell, comprising a carrier medium and active carbon as adsorption agent, wherein the active carbon is immobilized by addition of adhesive.

DE 10 2005 016 677 A1 discloses a filter element with a multi-layer filter material in which an active layer, arranged at the inflow side and provided with active carbon fibers, is provided which is adjoined at the outflow side by an adsorber layer with grainy adsorbents. A further active layer with active carbon fibers can adjoin this adsorber layer at the outflow side. The adsorbents which are employed herein can comprise active carbon, zeolites, cyclodextrins, silicates, ion exchangers, and aluminosilicates.

DE 10 2012 007 503 A1 discloses a further adsorptive filter medium in which a plurality of first filter layers with a first adsorption substance and a plurality of second filter layers different from the first filter layers with a second adsorption substance are provided, which alternate and comprise different flow resistances or pressure losses.

DE 10 2009 021 020 A1 discloses a further adsorptive filter material which contains an exchanger resin laden with metal cations.

Acidic cation exchanger resins have become established for the separation of alkaline gases such as ammonia (NH₃) and trimethyl amine (TMA). In comparison to impregnated active carbons, ion exchangers comprise in this context an adsorption capacity which is multiple times higher, but have the disadvantage of an inferior spontaneity. In other words, an ion exchanger can remove harmful gases from an air flow over a long period of time but has a disadvantageous start behavior which can lead to undesirable harmful gas breakthroughs. Furthermore, such ion exchanger resins are comparatively expensive because their mass-based price corresponds approximately to three times that of an impregnated active carbon.

The invention has therefore the object to provide an air filter medium which comprises an optimized adsorption kinetics for alkaline gases such as NH₃ and TMA, in particular an improved initial separation efficiency, and in this context can be made available less expensively than known air filter media for gas adsorption.

### SUMMARY OF THE INVENTION

This object is solved by an air filter medium, in particular for an interior air filter, for an intake air filter of a fuel cell or for a fume filter, wherein the air filter medium comprises a predetermined inflow side and a predetermined outflow side, and wherein the air filter medium can be flowed through from the inflow side to the outflow side in a flow direction, the air filter medium comprising:
an ion exchanger layer comprising ion exchanger particles;
an impregnation layer comprising impregnated active carbon particles;
wherein:
the impregnation layer is arranged downstream of the ion exchanger layer;
the impregnated active carbon particles of the impregnation layer are impregnated with an acidic impregnation agent comprising at least one inorganic acid, wherein the inorganic acid is selected from the group consisting of phosphoric acid, sulfuric acid, and hydrochloric acid;
a grammage of the ion exchanger particles in the ion exchanger layer lies in a range between 150 g/m² and 350 g/m²;
a grammage of the impregnated active carbon particles in the impregnation layer lies in a range between 150 g/m² and 350 g/m²;
wherein the air filter medium comprises furthermore an active layer comprising non-impregnated active carbon particles.

The object is further solved by a filter medium body comprising an air filter medium according to the invention, wherein the air filter medium is in particular folded multiple times to a folded bellows.

The object is further solved by a filter element comprising a filter medium body according to the invention and a frame element which at least partially surrounds the filter medium body and is connected to the filter medium body.

The object is further solved by a use of the air filter medium according to the invention in an interior air filter, an intake air filter of a fuel cell or in a fume filter.

The dependent claims provide advantageous and expedient further developments, respectively.

The air filter medium according to the invention is suitable in particular for interior air filters of motor vehicles, intake air filters of fuel cells, or fume or exhaust filters. However, also applications in the field of air filtration of buildings or ventilation and air-conditioning devices are possible. Specifically, the air filter medium according to the invention is configured in particular for separation of NH₃, TMA, and methyl ethyl ketone (MEK). In addition, the air filter medium according to the invention separates also further hydrocarbons such as e.g., n-butane and toluene.

The air filter medium according to the invention comprises an ion exchanger layer comprising ion exchanger particles and an impregnation layer comprising impregnated active carbon particles. The impregnated active carbon particles of the impregnation layer are impregnated with an acidic impregnation agent comprising at least one inorganic acid, wherein the inorganic acid is selected from the group consisting of phosphoric acid, sulfuric acid, and hydrochloric acid. A grammage of ion exchanger particles in the ion exchanger layer lies in a range between 150 g/m² and 350 g/m². Furthermore, a grammage of the impregnated active carbon particles in the impregnation layer lies in a range between 150 g/m² and 350 g/m². In addition to the aforementioned inorganic acids, also organic acids such as e.g., citric acid can be used as a component of the acidic impregnation agent.

In embodiments, the grammage of the ion exchanger particles in the ion exchanger layer can amount to maximally 300 g/m², in particular maximally 260 g/m², and/or the grammage of the impregnated active carbon particles in the impregnation layer can amount to maximally 330 g/m², in particular maximally 290 g/m².

The lower limit of the grammages of the ion exchanger particles in the ion exchanger layer and of the impregnated active carbon particles in the impregnation layer is technically required in order to achieve in practice a sufficient packing density and, in this way, avoid in the layers the formation of bypass channels not covered by particles.

In air filter media known in the prior art, ion exchangers usually are used with grammages of more than 350 g/m², for a typical grain size of the ion exchanger particles in the range of 300 μm-1,200 μm. This is necessary in the prior art in order to achieve a required initial separation efficiency of >95%, for example, for NH₃, more precisely at a gas concentration of 10 ppm NH₃ and a typical media inflow speed of 0.2 m/s.

In contrast thereto, the air filter medium according to the invention achieves an initial separation efficiency of >95% for NH₃ and TMA with the aid of a significantly reduced grammage of the ion exchanger particles in the ion exchanger layer because it combines the ion exchanger layer with an impregnation layer comprising acid-impregnated active carbon particles. The impregnated active carbon comprises a better spontaneity in comparison to the ion exchanger and contributes therefore to a higher initial separation efficiency and improves in this way the Astart behavior@ and prevents initial gas breakthroughs. The ion exchanger, on the other hand, comprises a significantly higher adsorption capacity and contributes thus to maintaining the gas adsorption for longer periods of time.

In this way, the air filter medium according to the invention comprises an improved adsorption kinetics for alkaline gases, in particular NH₃ and TMA, and can be produced significantly more cost-effectively at the same time due to the significantly reduced grammage of the comparatively expensive ion exchanger material.

The impregnated active carbon particles can be impregnated in embodiments with 5% by mass or less of the acidic impregnation agent. This minimal impregnation proportion continues to provide the co-adsorption of hydrocarbons, in particular of methyl ethyl ketone (MEK), while the ion exchanger resin is very gas-specific and separates only alkaline gases.

An impregnated active carbon is understood as an active carbon comprising an impregnation applied onto the active carbon. The gas and/or odor substances to be removed are bonded chemically by the impregnation applied onto the active carbon or are converted by it into a form which can be adsorbed in a subsequent layer in the flow direction. In other words, the impregnations applied on the active carbon act chemisorptively with the respective gas or odor substance. The impregnation layer thus has additional chemisorption properties reinforcing the adsorption or adapting it to a predetermined compound profile.

Suitable active carbon types are, for example, active carbon types based on various raw materials and comprising various activation degrees. In this way, an additional advantageous adaptation to the target gas spectrum is possible. Preferred raw materials are in this context coconut, black coal, and charcoal, wherein coconut active carbon is preferred.

According to a further embodiment, a grammage of the ion exchanger particles in the ion exchanger layer can lie in a range between 200 g/m² and 350 g/m² and/or a grammage of the impregnated active carbon particles in the impregnation layer can lie in a range between 250 g/m² and 350 g/m².

In this context, the lower limit of the grammage of 200 g/m² for the ion exchanger particles describes the minimum applied amount which is required for an effective gas separation with still a minimal bypass behavior. The lower grammage range of 250 g/m² for the impregnated active carbon particles is the minimum applied amount which is required for an almost complete gas separation of the gas concentration which is still present at the outflow side of the ion exchanger layer. The upper grammage range of 350 g/m² describes respectively the weight per surface area of the adsorber which can be applied maximally per adsorber layer without risking limitations with respect to the mechanical load resistance of the filter medium.

The air filter medium comprises a predetermined inflow side and a predetermined outflow side. In this context, the air filter medium can be flowed through from the inflow side to the outflow side in a flow direction and the impregnation layer is arranged downstream of the ion exchanger layer. Due to the described arrangement, the ion exchanger, with a typical gas absorption capacity of >50 mg/g for concentrations about 10 ppm NH₃, can absorb the main load of the addressed target gas.

This is approximately 80% of the added raw gas quantity in the first 10 minutes of the measurement under exemplary testing conditions, under which an air volume flow having added thereto 10 ppm NH₃ is passed at 400 Nm³/h (inflow speed at the filter medium 0.23 m/s) through a filter medium body comprising the air filter medium and the NH₃ concentration is measured downstream of the filter medium body by means of FTIR. The impregnation layer with a significantly smaller gas absorption capacity of approximately 5 mg/g can thus absorb the harmful gas for a multiple times longer measuring duration and provide the required spontaneity across a longer period of time in comparison to the inflow side arrangement.

The air filter medium comprises furthermore an active layer comprising non-impregnated active carbon particles and arranged in particular downstream of the impregnation layer. In particular, the impregnation layer in this context can be arranged between the active layer and the ion exchanger layer. In the described arrangement, the impregnation layer can be used as a prefilter for hydrocarbon adsorption. Due to the relatively low degree of impregnation in the embodiments of approximately 5% by mass, the impregnation layer still has approximately 80% of its adsorption capacity for hydrocarbons, such as e.g., MEK, in comparison to the active layer without impregnation. Thus, the impregnation layer upstream of the active layer can absorb already a portion of the hydrocarbons and extend the service life of the active layer.

In other embodiments, the active layer can be arranged however also upstream of the impregnation layer. In particular, the active layer can also be arranged between the impregnation layer and the ion exchanger layer.

In embodiments, an average grain size of the ion exchanger particles can amount to 300 μm to 1,200 μm. The selection of the grain size in the disclosed range ensures a grain diameter as small as possible required for the substance transport and the reaction kinetics while providing at the same time a pressure loss as low as possible. The average grain size can be determined in particular according to ASTM D 2862.

In embodiments, an average grain size of the impregnated active carbon particles can amount to 350 μm to 550 μm. The selection of the grain size in the disclosed range ensures a grain diameter as small as possible required for the substance transport and the reaction kinetics while providing at the same time a pressure loss as low as possible. The average grain size can be determined in particular according to ASTM D 2862.

For determining the average grain size based on ASTM D 2862, a representative sample of the fill is placed into a screen tower with screens in decreasing size of the screen mesh width. The average grain size describes the theoretical grain diameter, resulting from a curve of the grain size distribution experimentally determined based on the afore described configuration, for which 50% of the grains are above this diameter and 50% below.

In embodiments, the ion exchanger particles can comprise strongly acidic cation exchangers which in particular comprise as a functional group an acidic group, in particular sulfonic acid, and a cation group of the H+ or Na+ form. The strongly acidic cation exchanger can be of the gel type or of the macroporous type. As a basic polymer, a polystyrene divinylbenzene copolymer is conceivable, for example.

Moreover, the impregnated active carbon particles of the impregnation layer and/or the non-impregnated active carbon particles of the active layer and/or the ion exchanger particles of the ion exchanger layer can be bonded, in particular cross-linked, by addition of adhesive. The adhesive immobilizes the particles in the respective layer and prevents that they flow out, in particular under vibration load.

This bond, in particular cross-linking, is achieved advantageously by the addition of adhesive whose adhesive threads adhere to the surface of the active carbon or ion exchanger particles and connect different active carbon or ion exchanger particles to each other without however impairing the adsorption performance of the active carbon or ion exchanger particles. Suitable adhesives encompass, for example, reactive hot melt adhesives, e.g., on the basis of polyurethane or silane. Possible is also a thermoplastic adhesive which is produced e.g., on the basis of polyolefins. In embodiments, the adhesive can be a reactive hot melt adhesive.

According to a further embodiment, the air filter medium can comprise at least one carrier layer which in particular is arranged at the inflow side, wherein in particular the carrier layer comprises, or is comprised of, a synthetic nonwoven material.

In this context, the carrier layer can be carrier of the particles at least of one of the layers. In particular, the carrier layer can be carrier of the ion exchanger particles of the ion exchanger layer. In other embodiments, the carrier layer can however also be carrier of the impregnated active carbon particles of the impregnation layer or carrier of the non-impregnated active carbon particles of the active layer. The carrier layer, for example, is embodied as a carrier layer or bed which, as needed, takes on a mechanical (pre-)filtration of particulate contaminants of the gas flow to be purified. The nonwoven material can comprise, for example, fibers on the basis of polyester, polypropylene, polyamide, polyacrylonitrile and/or polycarbonate.

In an embodiment, the ion exchanger layer forms a layer which immediately adjoins the carrier layer and is preferably connected by an adhesive to the carrier layer. In this context, gluing the ion exchanger layer onto the carrier layer is conceivable as well as the adhesive connection by means of adhesive threads which have not yet cured and which are applied onto the ion exchanger particles. The carrier layer delimits thus the ion exchanger layer at least at one side and is at the same time connected to the ion exchanger layer.

According to a further expedient embodiment, at least one of the layers ion exchanger layer, impregnation layer and/or active layer can be sealed at their length and/or width sides so that a boundary of the layers can be realized at the lateral surfaces. Sealing at the length and/or width sides prevents that particles can flow out of the layers, increases the stability, and prevents an undesirable delamination.

In a further embodiment, the air filter medium can comprise at least one particle filter layer which is in particular arranged at the outflow side. The particle filter layer can comprise, or be comprised of, a synthetic nonwoven material. In particular, a separation efficiency of the particle filter layer can be higher than a separation efficiency of the carrier layer.

In embodiments, the particle filter layer fulfills the filtration class H13 or H14 according to DIN EN 1822-1. In other words, the particle filter layer can be a HEPA filter medium. Conceivable is the use of a nonwoven material of plastic material or glass fibers in the particle filter layer. In embodiments, the particle filter layer can further comprise a HEPA aerosol medium on membrane basis, for example, of ePTFE.

As an alternative or in addition, between at least one of the layers of the group consisting of ion exchanger layer, active layer, and impregnation layer and a neighboring layer, a separation layer can be arranged which comprises, or is comprised of, a synthetic nonwoven material. The separation layer in this context can have a structure comparable to the carrier layer and in particular can have a lower separation efficiency than the particle filter layer. It can be in particular provided that the impregnated active carbon particles of the impregnation layer and/or the non-impregnated active carbon particles of the active layer are immobilized by means of an adhesive in relation to a separation layer.

Finally, the air filter medium can comprise according to a further embodiment at least one further adsorption layer comprising adsorbent particles, wherein the adsorbent particles comprise in particular an active carbon, a zeolite, an ion exchanger and/or a molecular sieve. In this way, an additional advantageous adaptation to a given target gas spectrum is possible so that the air filter medium according to the invention can be adapted even better to the specific parameters of a specific gas and odor substance profile.

A further aspect of the present invention concerns a filter medium body comprising an air filter medium according to the invention which is folded in particular several times to a folded bellows or is present in a multi-corrugated shape in order to form a so-called compact filter. Alternatively, the air filter medium according to the invention can be present in the filter medium body also in a stacked form.

Yet another aspect of the present invention concerns a filter element comprising a filter medium body according to the invention as well as a frame element which surrounds the filter medium body at least partially and is connected to the filter medium body. The frame element can comprise lateral bands of a foam or nonwoven material glued onto the end edges of the folded bellows and/or head bands of a foam or nonwoven material fastened to end fold sections of the folded bellows. Alternatively, the frame element can comprise a plastic frame into which the filter medium body is glued or overmolded by a material of the frame element. The frame element surrounds the filter medium body in particular completely. In embodiments, a circumferentially extending seal element, which is configured for sealing the filter element in a filter device, in particular in an interior air filter, in an intake air filter of a fuel cell, or in a fume filter, can be arranged at the frame element.

Finally, a further aspect of the present invention concerns the use of an air filter medium according to the invention in an interior air filter, in an intake air filter of a fuel cell, or in a fume filter.

### BRIEF DESCRIPTION OF THE DRAWINGS

FIG. 1 shows a greatly simplified section view of an air filter medium according to an embodiment not in accordance with the invention.

FIGS. 2a, 2b, 2c show greatly simplified section views of an air filter element according to the invention according to a second embodiment.

FIG. 3 shows a greatly simplified section view of an air filter medium according to the invention according to a third embodiment.

FIG. 4 shows a greatly simplified section view of an air filter medium according to the invention according to a fourth embodiment.

FIG. 5 shows an isometric view of an embodiment of a filter medium body according to the invention.

FIG. 6 shows an isometric view of an embodiment of a filter element according to the invention.

FIG. 7 shows NH₃ breakthrough curves of an air filter medium according to the invention in comparison to an air filter medium of the prior art.

### DESCRIPTION OF PREFERRED EMBODIMENTS

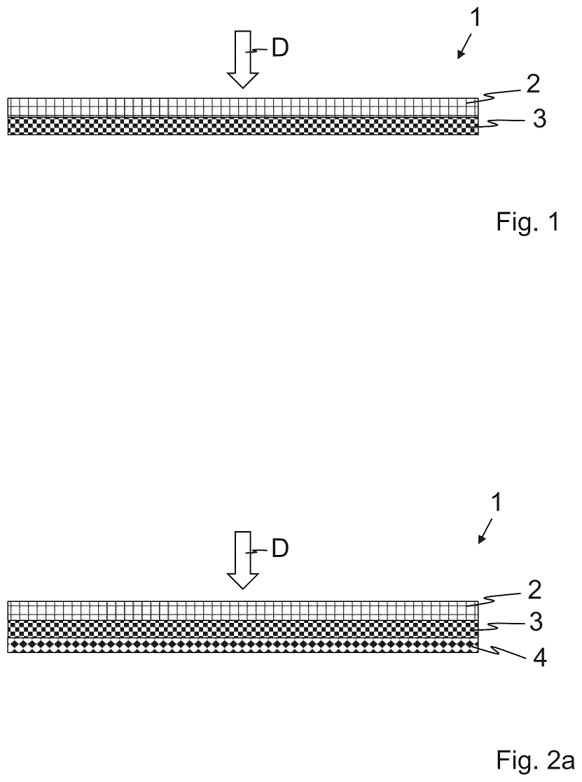

In FIG. 1, an air filter medium 1 according to an embodiment not in accordance with the invention is illustrated. The air filter medium 1 comprises an ion exchanger layer 2 comprising ion exchanger particles and an impregnation layer 3 comprising impregnated active carbon particles. The impregnated active carbon particles of the impregnation layer 3 are impregnated with an acidic impregnation agent comprising at least one inorganic acid, wherein the inorganic acid is selected from the group consisting of phosphoric acid, sulfuric acid, and hydrochloric acid. A grammage of the ion exchanger particles in the ion exchanger layer 2 lies in a range between 150 g/m² and 350 g/m² and a grammage of the impregnated active carbon particles in the impregnation layer 3 in a range between 150 g/m² and 350 g/m². The air filter medium 1 comprises a predetermined inflow side and a predetermined outflow side, wherein the air filter medium 1 in operation can be flowed through from the inflow side to the outflow side in a flow direction D and the impregnation layer 3 is arranged downstream of the ion exchanger layer 2.

Despite a grammage in the ion exchanger layer 2 being reduced compared to air filter media of the prior art, the air filter medium 1 according to the invention achieves surprisingly, an initial separation efficiency of >95% for NH₃ and TMA because it combines the ion exchanger layer 2 with the impregnation layer 3 comprising acid-impregnated active carbon particles. The impregnated active carbon of the impregnation layer 3 comprises a better spontaneity in comparison to the ion exchanger layer 2 and contributes therefore to the high initial separation efficiency and improves in this way the Astart behavior@ and prevents initial gas breakthroughs. The ion exchanger layer 2 on the other hand exhibits a significantly higher adsorption capacity and contributes thus to maintaining the gas adsorption over longer periods of time.

The impregnated active carbon particles of the impregnation layer 3 can be impregnated, for example, with 5% by mass or less of the acidic impregnation agent. This minimal impregnation proportion continues to provide the co-adsorption of hydrocarbons, in particular of methyl ethyl ketone (MEK), while the ion exchanger layer 2 is very gas specific and separates only alkaline gases.

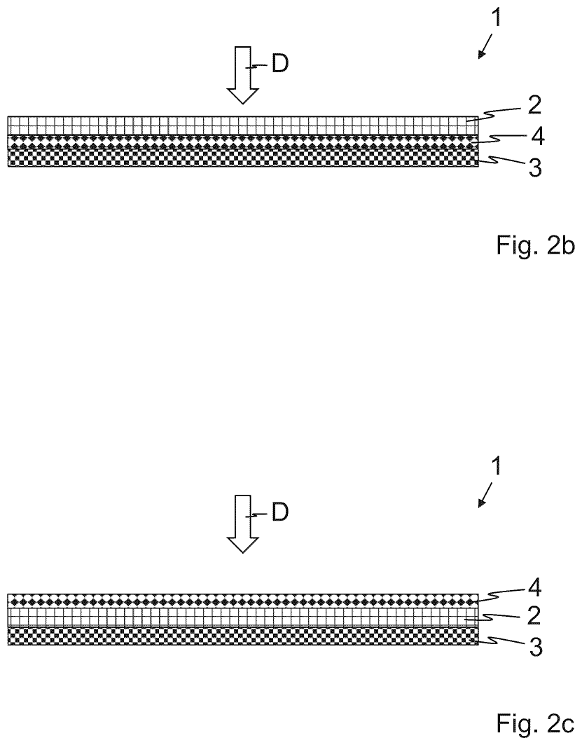

In FIG. 2a to FIG. 2c, an air filter medium 1 according to a second embodiment of the invention is illustrated which differs from the first embodiment in that it comprises an active layer 4 which comprises non-impregnated active carbon particles. According to FIG. 2a, the active layer 4 is arranged downstream of the impregnation layer 3, wherein the impregnation layer 3 is arranged between ion exchanger layer 2 and active layer 4. This has the advantage that the impregnation layer 3 can be used as a prefilter for hydrocarbon adsorption. Due to the relatively minimal impregnation degree of approximately 5% by mass in embodiments, the impregnation layer still has approximately 80% of the adsorption capacity for hydrocarbons such as e.g., MEK in comparison to the active layer 4 without impregnation. Thus, the impregnation layer 3 upstream of the active layer 4 can already absorb a portion of the hydrocarbons and extend the service life of the active layer 4.

According to FIG. 2b on the other hand, the active layer 4 is arranged upstream of the impregnation layer 3, wherein the active layer 4 is arranged between ion exchanger layer 2 and impregnation layer 3. According to FIG. 2c finally, the active layer 4 is arranged upstream of the impregnation layer 3, wherein the ion exchanger layer 2 is arranged between active layer 4 and impregnation layer 3.

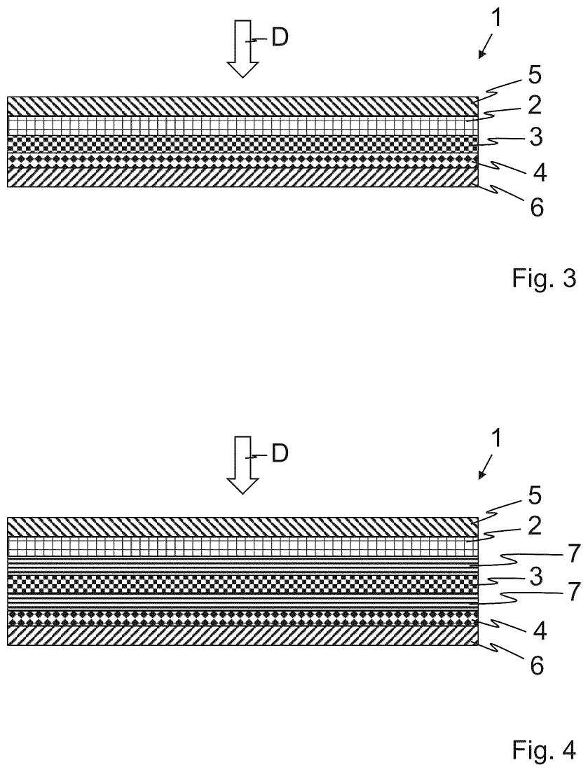

FIG. 3 shows an air filter medium 1 according to the invention according to a third embodiment which illustrates a further development of the second embodiment illustrated in FIG. 2a. The air filter medium 1 comprises at the inflow side a carrier layer 5 in relation to which the ion exchanger particles of the ion exchanger layer 2 are immobilized.

The carrier layer 5 comprises, or is comprised of, an in particular synthetic nonwoven material and permits therefore a mechanical support or holding function for the ion exchanger particles as well as also a (pre-)filtration of particulate contaminants of the air flow to be purified. The nonwoven material can comprise, for example, fibers on the basis of polyester, polypropylene, polyamide, polyacrylonitrile and/or polycarbonate.

The ion exchanger layer 2 adjoins immediately the carrier layer 5, wherein the ion exchanger particles of the ion exchanger layer 2 are connected, for example, by an adhesive to the carrier layer 5. In particular, the ion exchanger particles can be connected by a net of adhesive threads to the carrier layer 5, wherein the net of adhesive threads is advantageously configured such that it does not unnecessarily constrict a flow cross section of the air filter medium 1 in order to not generate an excessive pressure loss.

Furthermore, the air filter medium 1 comprises a particle filter layer 6 which is arranged at the outflow side and comprises, or is comprised of, an in particular synthetic nonwoven material. A separation efficiency of the particle filter layer 6 is in particular higher than a separation efficiency of the carrier layer 5. In other words, the particle filter layer 6 has a higher degree of separation than the carrier layer 5 so that fine and/or finest particles are separated mainly by the particle filter layer 6. The particle filter layer 6 can fulfill, for example, filtration class H13 or H14 according to DIN EN 1822-1.

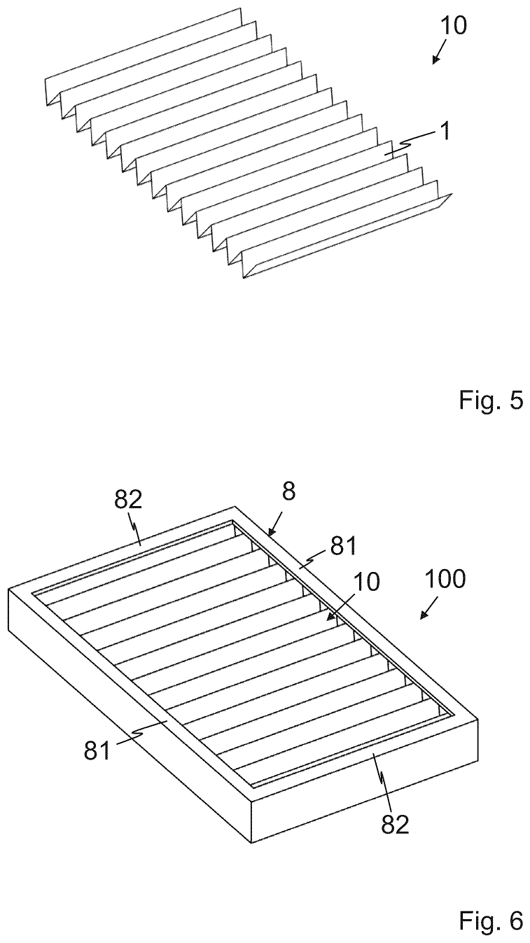

The fourth embodiment illustrated in FIG. 4 of the air filter medium 1 according to the invention further develops the third embodiment illustrated in FIG. 3 in that a separation layer 7 is arranged, respectively, between the ion exchanger layer 2 and the impregnation layer 3 as well as between the impregnation layer 3 and the active layer 4.

The separation layers 7 can comprise, or be comprised of, a synthetic nonwoven material. The separation layers 7 can have in particular a structure comparable to the carrier layer and have preferably also a lower separation efficiency than the particle filter layer 6. The impregnated active carbon particles of the impregnation layer 3 are immobilized in relation to one of the carrier layers 7 by means of an adhesive and the non-impregnated active carbon particles of the active layer 4 are immobilized in relation to another carrier layer 7 by means of an adhesive. When producing the air filter medium 1, it is possible in this way to first cover the individual layers (carrier layer, separation layers) with adsorption particles (ion exchanger particles, impregnated active carbon particles, non-impregnated active carbon particles) and to immobilize them relative to the carrier layer 5 or separation layers 7 by adhesive and combine these individual layers subsequently to a layer composite in order to obtain the air filter medium 1 according to the invention. The use of separation layers 7 between neighboring adsorbent layers (ion exchanger layer, impregnation layer, active layer) improves the fixation of the adsorbents in the layer composite of the air filter medium 1 according to the invention and counteracts a loss of adsorbent particles by “trickling out”.

FIG. 5 shows a filter medium body 10 according to the invention which comprises an air filter medium 1 according to the invention which is folded multiple times to a folded bellows. The fold heights and fold spacings as well as the dimensions of the filter medium body 10 in the plane (width, length) can be determined by a person skilled in the art as a function of the technical boundary conditions of a concrete application situation.

In FIG. 6, a filter element 100 according to the invention is illustrated which comprises a filter medium body 10 according to the invention as well as a frame element 8 completely surrounding the filter medium body 10. The frame element 8 is connected to the filter medium body 10, in particular connected to the end edges as well as end fold sections of the folded bellows 10. The frame element 8 comprises lateral bands 81 attached to end edges of the folded bellows 10 as well as head bands 82 attached to end fold sections of the folded bellows 10. The head bands 82 and/or lateral bands 81 can comprise, or be comprised of, in particular a foam or nonwoven material. The head bands 82 and/or lateral bands 81 can be in particular glued to the folded bellows 10, for example, by a curable hot melt adhesive e.g., on the basis of polyurethane or silane. Possible is also a thermoplastic adhesive produced e.g., on the basis of polyolefins. In embodiments, the adhesive can be a reactive hot melt adhesive.

As an alternative, the head bands 82 and/or lateral bands 81 can also be comprised of a (hard) plastic material. Furthermore, it is possible that all head bands 82 and lateral bands 81 of the frame element 8 are formed together as one piece, wherein the frame element 8 can comprise in particular a (hard) plastic frame into which the folded bellows 10 is glued or overmolded by a material of the frame element 8.

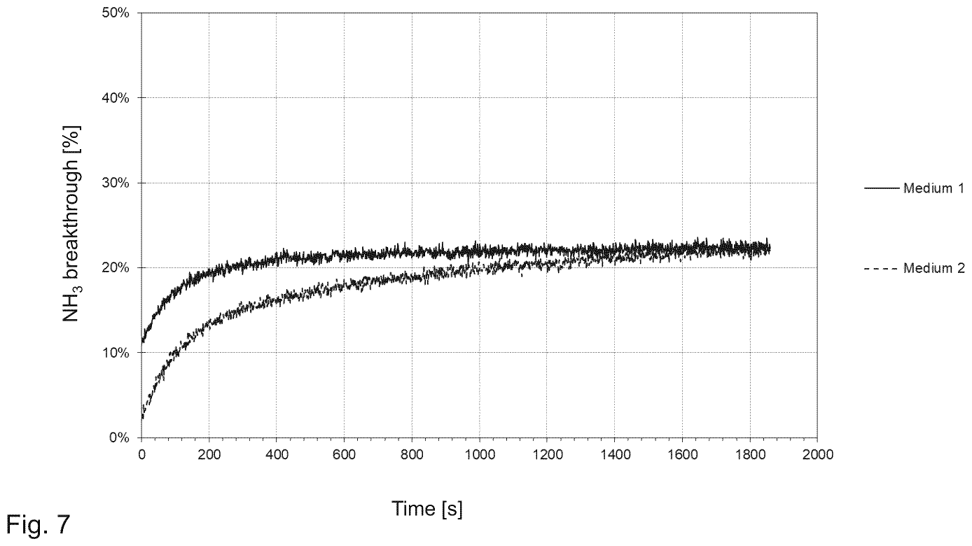

In FIG. 7, two NH₃ breakthrough curves are illustrated which have been experimentally determined. The upper curve (“Medium 1”) illustrated by a solid line is an air filter medium according to the prior art and the lower curve (“Medium 2”) illustrated by dashed line is an air filter medium according to the invention.

In this context, the construction of the compared air filter media was as described in the table below.

| | medium 1 | medium 2 | unit |
|---|---|---|---|
| strongly acidic cation exchanger | 300 | 250 | g/m² |
| active carbon impregnated with 5% | — | 280 | g/m² |
| by mass H₃PO₄ | | | |
| non-impregnated active carbon | 500 | 280 | g/m² |
| (steam-activated) | | | |
| total grammage | 800 | 810 | g/m² |

The strongly acidic cation exchanger is specifically a dried macroporous cation exchanger on the basis of a polystyrene divinylbenzene copolymer comprising sulfonic acid as a functional group.

The impregnated active carbon is specifically a grainy active carbon, impregnated with 5% by mass phosphoric acid, with a water contents of approximately 5% and an average grain size of approximately 0.5 mm.

The non-impregnated active carbon is specifically a steam-activated grainy active carbon on the basis of coconut shells with a water content of <3%.

Folded filter medium bodies with a filter surface of 0.48 m² were formed of the air filter media (“Medium 1” and “Medium 2”) for the comparative measurements. The comparative measurements were performed at a temperature of 23° C. at 50% relative humidity in conformity with ISO 11155-2.

During the measurement, an air volume flow, having added thereto 10 ppm NH₃, at 400 Nm³/h (inflow speed at the filter medium 0.23 m/s) was passed through the filter medium body comprising the air filter medium and the NH₃ concentration measured downstream of the filter medium body by means of an FTIR (Fourier transformation infrared spectrometer), based on which the degree of breakthrough illustrated in the diagram along the Y axis can be calculated.

From the measurement curve of the air filter medium according to the prior art (“Medium 1”) it can be seen that the initial separation efficiency (t=0 s) is relatively minimal at a breakthrough of approximately 11% and thus conventional specifications cannot be fulfilled.

The air filter medium (“Medium 2”) according to the invention on the other hand exhibits a significantly improved initial separation efficiency (t=0 s) at a breakthrough of approximately 2.5%, wherein the curve over time approaches the course of the curve determined for the Medium 1. This adsorption kinetics for NH₃ improved in particular with respect to the initial separation efficiency is achieved by the air filter medium according to the invention by the use of active carbon impregnated with 5% by mass H₃PO₄ in the impregnation layer because—in contrast to the ion exchanger layer—it contributes to an optimized start behavior. The ion exchanger layer on the other hand comprises a significantly higher adsorption capacity for NH₃ and other alkaline gases and contributes thus to maintaining the gas adsorption over longer periods of time.

Accordingly, the air filter medium according to the invention comprises a surprisingly improved initial separation efficiency for NH₃ while the total separation efficiency over longer periods of time is also improved or at least lies at the same level as for an air filter medium of the prior art that does not comprise impregnated active carbon.

What is claimed is:

1. An air filter medium comprising:
a predetermined inflow side and a predetermined outflow side, wherein the air filter medium is configured to be flowed through from the predetermined inflow side to the predetermined outflow side in a flow direction;
an ion exchanger layer comprising ion exchanger particles;
an impregnation layer comprising impregnated active carbon particles, wherein the impregnation layer is arranged downstream of the ion exchanger layer;
an active layer comprising non-impregnated active carbon particles;
wherein the impregnated active carbon particles of the impregnation layer are impregnated with an acidic impregnation agent comprising at least one inorganic acid, wherein the at least one inorganic acid is selected from the group consisting of phosphoric acid, sulfuric acid, and hydrochloric acid;
wherein a grammage of the ion exchanger particles in the ion exchanger layer lies in a range between 150 g/m² and 350 g/m²;
wherein a grammage of the impregnated active carbon particles in the impregnation layer lies in a range between 150 g/m² and 350 g/m².

2. The air filter medium according to claim 1, wherein the grammage of the ion exchanger particles in the ion exchanger layer lies in a range between 200 g/m² and 350 g/m² and/or the grammage of the impregnated active carbon particles in the impregnation layer lies in a range between 250 g/m² and 350 g/m².

3. The air filter medium according to claim 1, wherein the active layer is arranged downstream of the impregnation layer.

4. The air filter medium according to claim 1, wherein an average grain size of the ion exchanger particles amounts to 300 μm to 1,200 μm.

5. The air filter medium according to claim 1, wherein an average grain size of the impregnated active carbon particles amounts to 350 μm to 550 μm.

6. The air filter medium according to claim 1, wherein the ion exchanger particles comprise strongly acidic cation exchangers comprising as a functional group an acidic group and comprising a cation group selected from H+ and Na+.

7. The air filter medium according to claim 6, wherein the acidic group is sulfonic acid.

8. The air filter medium according to claim 1, further comprising an adhesive bonding one or more of the particles selected from the group consisting of the impregnated active carbon particles of the impregnation layer, the non-impregnated active carbon particles of the active layer, and the ion exchanger particles of the ion exchanger layer to each other.

9. The air filter medium according to claim 8, wherein the one or more particles selected from the group consisting of the impregnated active carbon particles of the impregnation layer, the non-impregnated active carbon particles of the active layer, and the ion exchanger particles of the ion exchanger layer are cross-linked by the adhesive.

10. The air filter medium according to claim 1, further comprising at least one carrier layer.

11. The air filter medium according to claim 10, wherein the at least one carrier layer is arranged at the predetermined inflow side.

12. The air filter medium according to claim 10, wherein the at least one carrier layer comprises a synthetic nonwoven material.

13. The air filter medium according to claim 1, further comprising at least one particle filter layer.

14. The air filter medium according to claim 13, wherein the at least one particle filter layer is arranged at the predetermined outflow side.

15. The air filter medium according to claim 13, wherein the at least one particle filter layer comprises a synthetic nonwoven material.

16. The air filter medium according to claim 1, further comprising one or more separation layers arranged between at least one of the layers selected from the group consisting of the ion exchanger layer, the active layer, and the impregnation layer, and a respective neighboring layer arranged adjacent to said at least one selected layer.

17. The air filter medium according to claim 16, wherein the one or more separation layers comprise a synthetic nonwoven material.

18. The air filter medium according to claim 1, comprising at least one adsorption layer comprising adsorption particles, wherein the adsorption particles comprise one or more adsorption materials selected from the group consisting of an active carbon, a zeolite, an ion exchanger, and a molecular sieve.

19. A filter medium body comprising an air filter medium according to claim 1, wherein the air filter medium is folded multiple times to a folded bellows.

20. A filter element comprising:
a filter medium body comprising an air filter medium according to claim 1, wherein the air filter medium is folded multiple times to a folded bellows; and
a frame element connected to the filter medium body and at least partially surrounding the filter medium body.
